(19) United States
(12) Patent Application Publication
(10) Pub. No.: US 2026/0155428 A1
(43) Pub. Date: Jun. 4, 2026

(54) LITHIUM SECONDARY BATTERY AND METHOD OF MANUFACTURING SAME

(71) Applicant: BEILab corp., Ansan-si (KR)

(72) Inventors: Youngjin YOON, Winchester, MA (US); Myungjun KIM, Seoul (KR); Changdeuck BAE, Suwon-si (KR)

(21) Appl. No.: 19/064,695

(22) Filed: Feb. 27, 2025

(30) Foreign Application Priority Data
Nov. 29, 2024 (KR) 10-2024-0175022

(51) Int. Cl. H01M 10/0525; H01M 4/131; H01M 4/1391

(52) U.S. Cl. CPC H01M 10/0525; H01M 4/131; H01M 4/1391

(57) ABSTRACT

Disclosed are a lithium secondary battery configured such that a separator and a cathode plate are disposed between an anode current collector and a cathode current collector and an electrolyte is provided between the anode current collector and the cathode plate, in which the cathode plate is formed by pressing a cathode active material powder, and the cathode plate is coated with a sacrificial material formed of a compound containing lithium, and a method of manufacturing the same.

### BACKGROUND OF THE INVENTION

### Field of the Invention

The present invention relates to a lithium secondary battery and a method of manufacturing the same, and more particularly, to an anode-free lithium secondary battery and a method of manufacturing the same, in which battery lifespan performance may be improved by applying a sacrificial material onto a cathode plate using a deposition process, and output and capacity performance of the battery may be increased by improving electrical conductivity of a cathode.

### Description of the Related Art

Lithium secondary batteries are manufactured by forming an anode and a cathode using materials capable of intercalation and deintercalation of lithium ions and placing an organic electrolyte or polymer electrolyte between the cathode and the anode, and serve to generate electrical energy by oxidation reaction and reduction reaction when lithium ions are intercalated and deintercalated at the cathode and anode.

Silicon has been receiving attention as an anode active material for developing next-generation lithium secondary batteries with high capacity and high energy density. However, silicon has the problem of volume expansion, so thorough research is ongoing to use lithium metal alone as an anode active material. Meanwhile, lithium metal, having high reactivity, spontaneously reacts with the liquid electrolyte, forming a solid-electrolyte interface (SEI) layer. The SEI layer has inferior physical and electrochemical properties, so side reaction occurs during repeated charge/discharge cycles, thus deteriorating the efficiency characteristics of lithium secondary batteries and causing surface reaction. Thereby, lithium grows in a dendrite shape, causing a short circuit in the battery, so there is a risk of explosion. In addition, there is a disadvantage in that stability of the lithium secondary battery system deteriorates owing to volume change that occurs as lithium ions are porously deposited on the surface of lithium metal due to non-uniform reaction.

Moreover, lithium films (lithium layers) are not only easily oxidized but may also melt at relatively low temperatures, making it difficult to manufacture the same and maintain performance thereof, and there is a problem of increasing the unit price of products due to high price thereof.

In lithium metal batteries, anode-free technology without the use of a lithium film (lithium layer) for the anode is able to solve the safety problem described above and drastically lower the process cost. However, anode-free technology has the problem of shortening the battery lifespan.

Meanwhile, there is disclosed a conventional method of forming a cathode plate by pre-coating particles of a cathode active material (e.g., a cathode active material powder) with a sacrificial material (e.g., Li₂O, etc.) that is easily decomposed at high voltage and then pressing the cathode active material coated with the sacrificial material.

This conventional technology enables formation of a cathode plate by pre-coating the cathode active material with the sacrificial material as an insulator and then pressing the cathode active material pre-coated with the sacrificial material, but has the problem of inhibiting conductivity (electrical conductivity) of the cathode plate due to the sacrificial material as an insulator.

Furthermore, when the cathode plate is formed by pressing the cathode active material pre-coated with the sacrificial material, there is a problem in that the cathode capacity (cathode density or density of the cathode active material) of the formed cathode plate is lowered, ultimately decreasing capacity of the battery.

### CITATION LIST

### Patent Literature

Korean Patent Application Publication No. 10-2019-0100078

### SUMMARY OF THE INVENTION

The present invention has been made keeping in mind the problems encountered in the related art, and an object of the present invention is to provide a lithium secondary battery and a method of manufacturing the same, in which battery lifespan performance may be improved by applying a sacrificial material onto a cathode plate using a deposition process, and output and capacity performance of the battery may be increased by improving electrical conductivity of a cathode.

In order to accomplish the above object, the present invention provides a lithium secondary battery configured such that a separator and a cathode plate are disposed between an anode current collector and a cathode current collector and an electrolyte is provided between the anode current collector and the cathode plate, in which the cathode plate is formed by pressing a cathode active material powder, and the cathode plate is coated with a sacrificial material formed of a compound containing lithium.

Since the cathode plate formed by pressing is coated with the sacrificial material, a decrease in the electrical conductivity of the cathode plate due to the sacrificial material acting as a resistor may be prevented.

Also, the sacrificial material may be formed of at least one selected from among lithium-containing oxides, chalcogenides, halides, nitrides, phosphates, carbonates, borates, silicates, sulfates, carbides, peroxides, amides, imides, and organolithium compounds.

Examples of the sacrificial material may include oxides, chalcogenides, halides, etc., all of which contain lithium.

Also, the sacrificial material may be applied onto the cathode plate after the cathode plate is formed from the cathode active material. Specifically, since the sacrificial material is applied onto the cathode plate after completion of formation of the cathode plate, the contact portion of cathode active material powder particles constituting the cathode plate is not coated with the sacrificial material, and thus, a decrease in the electrical conductivity of the cathode plate due to the sacrificial material may be prevented.

Also, after completion of formation of the cathode plate by pressing the cathode active material powder, the sacrificial material may be applied onto the outer surface of the cathode plate and around pores in the cathode plate. Accordingly, a sufficient amount of sacrificial material applied onto the outer surface of the cathode plate and around the pores in the cathode plate may be ensured, and simultaneously, a decrease in the electrical conductivity of the cathode plate due to the sacrificial material may be prevented.

Also, the cathode plate may be formed by mixing the cathode active material powder with at least one of a binder material or a conductive material followed by pressing. Here, the binder material serves to form the cathode plate more firmly, and the conductive material serves to improve the electrical conductivity of the cathode plate.

Also, the sacrificial material may not be applied onto the portion where the cathode active material powder particles are pressed and in contact with each other. Accordingly, electrical conduction between the cathode active material powder particles forming the cathode plate may be prevented from decreasing due to the sacrificial material.

Also, the lithium secondary battery according to the present invention may not include an anode active material or an anode plate. This is because, when the battery is charged, an anode layer may be formed through lithium ions provided from the sacrificial material and the cathode plate (or the cathode active material). Therefore, a more stable and inexpensive lithium secondary battery may be provided.

In addition, the present invention provides a method of manufacturing a lithium secondary battery. Specifically, the method of manufacturing a lithium secondary battery according to the present invention may include a first step of forming a cathode plate by pressing a cathode active material powder, a second step of coating the cathode plate with a sacrificial material formed of a compound containing lithium, and a third step of disposing a separator and the cathode plate coated with the sacrificial material between an anode current collector and a cathode current collector and providing an electrolyte between the anode current collector and the cathode plate.

Also, after the cathode plate is formed from the cathode active material in the first step, the sacrificial material may be applied onto the cathode plate in the second step.

After the cathode plate is completed through the first step, the sacrificial material is applied onto the cathode plate through the second step, so that a decrease in the electrical conductivity of the cathode plate due to the sacrificial material, which is an insulator, acting as a resistor, may be prevented.

Also, in the second step, the sacrificial material may be applied onto the outer surface of the cathode plate and around the pores in the cathode plate. Accordingly, a sufficient amount of sacrificial material may be ensured on the surface of the cathode plate and around the pores in the cathode plate, and simultaneously, a decrease in the electrical conductivity of the cathode plate due to the sacrificial material may be prevented.

Also, in the first step, the cathode active material powder may be mixed with at least one of a binder material or a conductive material followed by pressing, thereby forming the cathode plate.

Also, in the second step, the sacrificial material may not be applied onto the portion where the cathode active material powder particles are pressed and in contact with each other. Accordingly, electrical conduction between the cathode active material powder particles forming the cathode plate may be prevented from decreasing due to the sacrificial material.

Moreover, in the method of manufacturing a lithium secondary battery according to an embodiment of the present invention, the lithium secondary battery may not include an anode active material or an anode plate. Specifically, the method of manufacturing a lithium secondary battery according to an embodiment of the present invention may not include providing an anode active material or forming or providing an anode plate. This is because, when the battery is charged, an anode layer may be formed through lithium ions provided from the sacrificial material and the cathode plate (or the cathode active material). Therefore, a method of manufacturing a more stable and inexpensive lithium secondary battery may be provided.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B show a lithium secondary battery according to an embodiment of the present invention;

FIG. 2 shows a lithium secondary battery according to a comparative example;

FIG. 3 shows a lithium secondary battery according to another comparative example;

FIG. 4 shows a lithium secondary battery according to still another comparative example; and

FIG. 5 is a flowchart showing a process of manufacturing a lithium secondary battery according to an embodiment of the present invention.

### DETAILED DESCRIPTION OF THE INVENTION

Hereinafter, a lithium secondary battery and a method of manufacturing the same according to an embodiment of the present invention will be described in detail with reference to the attached drawings. The attached drawings illustrate exemplary forms of the present invention and are provided only to explain the present invention in more detail, but the technical scope of the present invention is not limited thereby.

In addition, regardless of the drawing symbols, identical or corresponding components are given the same reference numbers and redundant descriptions thereof are omitted, and the size and shape of each component depicted may be exaggerated or reduced for convenience of explanation.

In addition, when describing the present invention, if it is determined that a detailed description of related known technology may obscure the gist of the present invention, a detailed description of the related known technology is omitted.

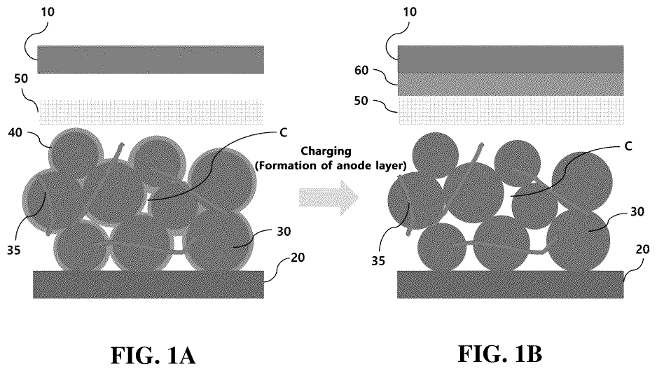

FIGS. 1A and 1B show a lithium secondary battery according to an embodiment of the present invention.

Specifically, FIG. 1A shows a state in which a sacrificial material is applied onto a cathode plate pre-formed through pressing of a cathode active material (or a cathode active material powder). Also, FIG. 1B shows a state in which the sacrificial material moves toward an anode current collector through charging to thus form an anode layer.

For example, during charging, lithium ions separated from the sacrificial material and the cathode active material (the cathode plate) may move toward the anode current collector and may be reduced on the anode current collector, forming an anode layer (i.e., a lithium layer). Specifically, during charging, lithium ions may first be separated from the sacrificial material and move toward the anode current collector (pre-charging), and then separated from the cathode active material and move toward the anode current collector (main charging).

Also, during discharging, the anode layer may be oxidized to generate lithium ions, some of the generated lithium ions may be reduced on the cathode active material (the cathode plate), and the remainder of the generated lithium ions may be reduced into a sacrificial material on the surface of the cathode plate.

In the following description, the cathode active material may indicate a cathode active material powder, and a cathode plate may be formed by pressing the cathode active material. Briefly, a cathode plate may be formed by pressing a cathode active material powder. Also, in the present invention, an anode active material and an anode plate are not provided separately. Hence, the present invention relates to an anode-free lithium secondary battery.

Referring to FIGS. 1A and 1B, the lithium secondary battery according to an embodiment of the present invention may include an anode current collector 10, a cathode current collector 20, a cathode active material 30, and a separator 50. A liquid electrolyte (not shown) may be provided between the anode current collector 10 and the cathode active material 30.

The material for the anode current collector 10 may be used without any particular limitation so long as it is a material having high conductivity without causing chemical changes in the lithium secondary battery. For example, the material for the anode current collector 10 may be copper, iron, aluminum, nickel, stainless steel, titanium, tantalum, gold, platinum, etc. Preferably, the anode current collector 10 is formed of copper or stainless steel.

The cathode current collector 20 may be formed of aluminum, an aluminum polymer composite, etc. The separator 50 and the cathode active material 30 may be disposed between the anode current collector 10 and the cathode current collector 20.

The separator 50 is disposed between the anode current collector 10 and the cathode plate formed from the cathode active material 30, thereby separating the anode current collector 10 and the cathode active material 30 (or the cathode plate) from each other. In addition, the separator 50 may provide a passage for lithium ions to move, and may be used without any particular limitation so long as it is commonly used as a separator in a lithium secondary battery.

For example, it is desirable that the separator 50 have low resistance to movement of ions through the electrolyte. For example, the separator 50 may be formed of at least one selected from among polyethylene, polypropylene, and a copolymer of polyethylene and polypropylene, and may also be provided in the form of a multilayer membrane of two or more layers thereof.

The electrolyte may be a liquid electrolyte. The liquid electrolyte may be a non-aqueous electrolyte solution. The non-aqueous electrolyte solution includes an electrolyte, which is a lithium salt, and a medium. The lithium salt may include lithium perchlorate (LiClO₄), lithium tetrafluoroborate (LiBF₄), lithium hexafluorophosphate (LiPF₆), lithium trifluoromethanesulfonate (LiCF₃SO₃), lithium hexafluoroarsenate (LiAsF₆), or lithium bis(trifluoromethanesulfonyl)imide (Li(CF₃SO₂)₂N). The medium may include ethylene carbonate, propylene carbonate, dimethyl carbonate, methyl ethyl carbonate, diethyl carbonate, fluoroethylene carbonate, acrylonitrile, γ-caprolactone, or a combination of two or more thereof. As an example, the medium may be a combination of dimethyl carbonate and fluoroethylene carbonate. The liquid electrolyte may further include an additive in addition to the lithium salt and the medium. For example, the additive may be LiNO₃.

The cathode active material 30 may include at least one selected from among lithium-containing nickel-cobalt-aluminum oxide (Li(NiCoAl)O₂, NCA), lithium-containing nickel-cobalt-manganese oxide (Li(NiCoMn)O₂, NCM or NMC), lithium manganese oxide (LiMn₂O₄, LMO), lithium iron phosphate (LiFePO₄, LFP), lithium cobalt oxide (LiCoO₂, LCO), and lithium-containing manganese-iron phosphate (LiMnₓFe₁₋ₓMn₄PO₄, LMFP).

When the lithium secondary battery is charged, lithium ions may be separated from the cathode active material 30, forming an anode layer 60 on the anode current collector 10. The process of forming the anode layer 60 by lithium ions separated from the cathode active material 30 is called main charging, and main charging may be performed simultaneously with or after the pre-charging described below.

For example, when the cathode active material 30 is formed of lithium-containing nickel-cobalt-manganese oxide, lithium ions may be separated from the cathode active material 30 as represented in Scheme 1 below. The separated lithium ions may be reduced on the anode current collector 10 (the lower surface of the anode current collector 10 in FIGS. 1A and 1B), forming an anode layer 60.

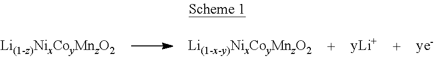

Lithium ions may be separated from the cathode active material 30 at a voltage of about 3.6 V to 4.3 V.

A cathode plate may be formed by pressing the cathode active material 30. Specifically, the cathode plate may be formed by pressing cathode active material powder particles. The pressing of the cathode active material powder particles may be performed by a known process such as roll pressing, etc.

The cathode active material 30 and the cathode current collector 20 may be pressed with the cathode active material 30 disposed on the cathode current collector 20. As such, at the same time as the cathode plate is formed, the cathode plate may be attached to the cathode current collector 20. Alternatively, after the cathode active material 30 is formed into a cathode plate through pressing, the cathode plate may be attached to the cathode current collector 20.

Also, the cathode plate may further include at least one of a binder material 35 or a conductive material. For example, the cathode plate may be formed by pressing a mixture in which the cathode active material 30 is mixed with at least one of the binder material 35 or the conductive material. Specifically, with the mixture disposed on the cathode current collector 20, the mixture and the cathode current collector 20 may be pressed together, or the cathode plate formed by pressing the mixture may be attached to the cathode current collector 20.

For example, the binder material 35 may include a polymer, and materials already known may be utilized as the binder material 35 and the conductive material.

Meanwhile, the lithium secondary battery according to the present invention may not include an anode active material or an anode plate. Specifically, the lithium secondary battery according to the present invention may selectively provide an anode layer 60 through the cathode plate described above and the sacrificial material 40 described below, even without an anode active material and an anode plate.

The lithium secondary battery may further include a sacrificial material 40 applied onto the cathode plate. Briefly, the cathode plate may be coated with the sacrificial material 40. The sacrificial material 40 may be applied onto the cathode plate by a known process such as roll coating, spray coating, slot die coating, blade coating, etc.

The sacrificial material 40 may be formed of a compound containing lithium (Li).

For example, the sacrificial material 40 may be formed of at least one selected from among lithium-containing oxides, chalcogenides, halides, nitrides, phosphates, carbonates, borates, silicates, sulfates, carbides, peroxides, amides, imides, and organolithium compounds.

For example, when the sacrificial material 40 is formed of lithium oxide, lithium ions may be separated from the sacrificial material as represented in Scheme 2 below. The separated lithium ions may be reduced on the anode current collector 10 (the lower surface of the anode current collector 10 in FIGS. 1A and 1B), forming an anode layer 60.

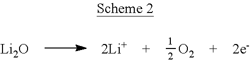

Lithium ions may be separated from the sacrificial material 40 at a voltage of about 3.0 V to 3.5 V. The process in which lithium ions are separated from the sacrificial material 40 to thus form an anode layer 60 is also called pre-charging.

The pre-charging and main charging described above may be performed sequentially or simultaneously based on the applied voltage.

As the sacrificial material 40 is applied onto the cathode plate, an anode layer formed of lithium in a lithium secondary battery may be selectively and efficiently formed even without an anode active material and an anode plate.

Also, the sacrificial material 40 is formed as an insulator. Hence, the sacrificial material 40 may act as a resistor in the cathode plate, and there is a concern that the electrical conductivity of the cathode plate may decrease due to the sacrificial material 40. However, according to the present invention, since the sacrificial material 40 is applied onto the pre-formed cathode plate, a decrease in the electrical conductivity of the cathode plate may be prevented.

Specifically, the sacrificial material 40 may be applied onto the cathode plate after the cathode plate is formed from the cathode active material 30. Accordingly, since the sacrificial material 40 is applied onto the outer surface of the cathode plate formed by pressing powder particles of the cathode active material 30, a decrease in the electrical conductivity of the cathode plate due to the sacrificial material 40 may be prevented.

In addition, when the cathode plate is formed by pressing powder particles of the cathode active material 30, a plurality of pores C may be formed in the cathode plate. The pores C may be formed between adjacent powder particles when powder particles of the cathode active material 30 are pressed against each other.

The sacrificial material 40 may also be applied around the pores C in the cathode plate. Specifically, the sacrificial material 40 may also be applied onto the outer surface of powder particles of the cathode active material 30 that define the pores C.

Specifically, after completion of formation of the cathode plate by pressing powder of the cathode active material 30, the sacrificial material 40 may be applied onto the outer surface of the cathode plate and around the pores C in the cathode plate. Accordingly, it is possible to prevent a decrease in the electrical conductivity of the cathode plate while ensuring that as much sacrificial material 40 as possible is applied onto the cathode plate.

Meanwhile, when powder particles of the cathode active material 30 are attached to each other by pressing, the sacrificial material 40 is not applied onto the portion where the powder particles are pressed and in contact with each other. Specifically, since the cathode plate is formed and then coated with the sacrificial material 40, the sacrificial material 40 cannot be applied onto the portion where the powder particles are in contact with each other by pressing. Accordingly, a decrease in the electrical conductivity of the cathode plate due to the sacrificial material 40 may be prevented.

Meanwhile, coating of the cathode plate of the present invention with the sacrificial material 40 may be distinguished from mixing or application of the sacrificial material with or onto the cathode active material 30 (i.e., the cathode active material powder) before formation of the cathode plate.

When the sacrificial material 40 is applied onto the cathode plate, the electrical conductivity, cathode capacity (cathode density), and battery capacity and lifespan may be improved compared to when the sacrificial material is mixed with or applied onto the cathode active material 30 (i.e., the cathode active material powder).

Hereinafter, the advantages of the lithium secondary battery according to the present invention will be described in more detail with reference to comparative examples.

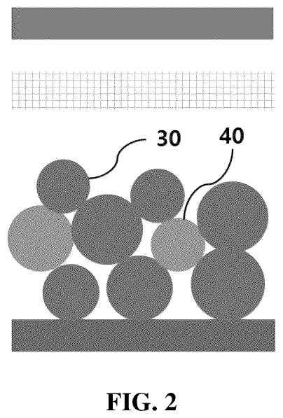

FIG. 2 shows a lithium secondary battery according to a comparative example.

Referring to FIG. 2, a cathode plate may be formed by pressing the cathode active material 30 and the sacrificial material 40, which are mixed. As such, based on a cathode plate having the same size (or the same thickness), the amount of the cathode active material 30 may decrease due to mixing of the sacrificial material 40 (mixing of sacrificial material powder), which may cause a problem of lowering cathode capacity, particularly battery capacity.

In addition, according to the comparative example illustrated in FIG. 2, when the amount of the sacrificial material 40 is decreased based on a cathode plate having the same size as that of the present invention, not only is the speed at which the anode layer is formed slowed during charging, but there is also a problem in that a sufficient anode layer (lithium layer) cannot be formed.

In contrast, in the present invention, since the sacrificial material 40 is applied onto the pre-finished cathode plate, larger cathode capacity may be obtained based on a cathode plate having the same size (or the same thickness), and pre-charging (formation of an anode layer) by the sacrificial material 40 may also be performed at a high speed.

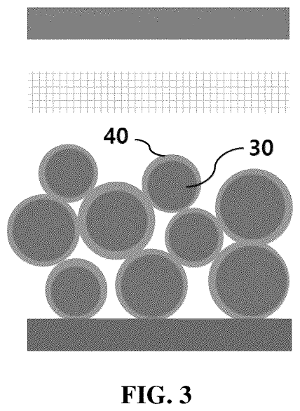

FIG. 3 shows a lithium secondary battery according to another comparative example.

Referring to FIG. 3, a cathode plate may be formed by pressing the cathode active material 30 in which each of powder particles of the cathode active material 30 is coated with the sacrificial material 40. As such, since the sacrificial material 40 acts as a resistor, a decrease in the electrical conductivity of the cathode plate (i.e., the electrical conductivity of the cathode active material) may occur.

In contrast, in the present invention, since the sacrificial material 40 is applied onto the surface of the pre-finished cathode plate, there is no case in which the sacrificial material 40 acts as a resistor in the cathode plate, and electrical conductivity may be improved.

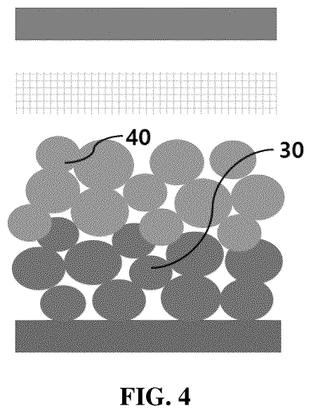

FIG. 4 shows a lithium secondary battery according to still another comparative example.

Referring to FIG. 4, a cathode plate may be formed by pressing a layer of the sacrificial material 40 disposed on a layer of the cathode active material 30. As such, based on a cathode plate having the same size (or the same thickness), the amount of the cathode active material 30 may decrease due to the layer thickness of the sacrificial material 40, which may cause a problem of lowering cathode capacity, particularly battery capacity.

In contrast, in the present invention, since the sacrificial material 40 is applied onto the pre-finished cathode plate, larger cathode capacity, particularly larger battery capacity, may be obtained based on a cathode plate having the same size (or the same thickness).

As described above, according to the present invention, the sacrificial material 40 may be prevented from acting as a resistor in the cathode plate, thereby improving electrical conductivity and also obtaining sufficient cathode capacity.

With reference to the other drawing, a method of manufacturing a lithium secondary battery according to an embodiment of the present invention will be described below.

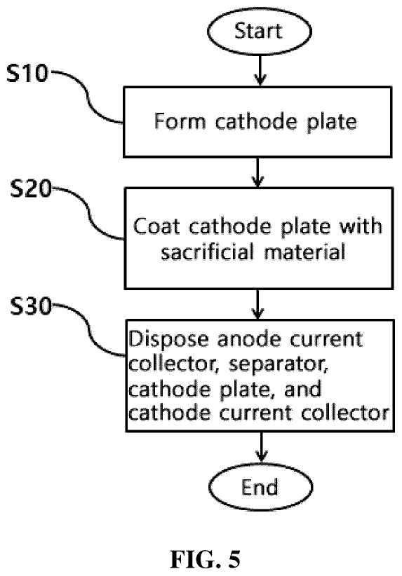

FIG. 5 is a flowchart showing a process of manufacturing a lithium secondary battery according to an embodiment of the present invention. Below, in describing the method of manufacturing a lithium secondary battery according to an embodiment of the present invention, it is obvious that the configuration of the lithium secondary battery described above may be equally applied to the method of manufacturing a lithium secondary battery.

Referring to FIG. 5, the method of manufacturing a lithium secondary battery according to an embodiment of the present invention may include a first step (S10) of forming a cathode plate, a second step (S20) of coating the cathode plate with a sacrificial material, and a third step (S30) of disposing the cathode plate between an anode current collector and a cathode current collector. The manufacturing method according to the present invention may not include manufacturing an anode plate using an anode active material.

In the first step (S10), the cathode plate may be formed by pressing a cathode active material powder. In the first step (S10), the cathode plate may be formed by mixing the cathode active material powder with at least one of a binder material or a conductive material followed by pressing. Specifically, the cathode plate may be formed by pressing a mixture in which the cathode active material powder is mixed with at least one of a binder material or a conductive material.

Also, in the first step (S10), the cathode current collector and the cathode active material powder (or the mixture) may be pressed with the cathode active material powder (or the mixture) disposed on the cathode current collector, whereby the cathode plate may be formed while attached to the cathode current collector.

The pressing process may be performed in a variety of known manners, and for example, a roll pressing process may be utilized.

In the second step (S20), the cathode plate may be coated with a sacrificial material formed of a compound containing lithium. For example, in the second step (S20), the sacrificial material may be applied onto the outer surface of the cathode plate and around one or more pores formed in the cathode plate. A plurality of pores may be formed in the cathode plate, in which case the sacrificial material may be applied around the plurality of pores.

The sacrificial material may be applied onto the cathode plate by a known process such as roll coating, spray coating, slot die coating, blade coating, etc.

Meanwhile, in the second step (S20), the sacrificial material may not be applied onto the portion where the cathode active material is pressed and in contact. Specifically, when the cathode plate is formed by pressing cathode active material powder particles, there may be a contact portion between adjacent cathode active material powder particles. As such, the sacrificial material is not and cannot be applied onto the portion where the cathode active material powder particles are in contact with each other.

In the method of manufacturing a lithium secondary battery according to the present embodiment, since the surface of the cathode plate that is pre-formed (pre-finished) is coated with the sacrificial material, it is possible to prevent a decrease in the electrical conductivity of the cathode plate due to the sacrificial material, which is an insulator.

Also, in the method of manufacturing a lithium secondary battery according to the present embodiment, since the surface of the cathode plate that is pre-formed (pre-finished) is coated with the sacrificial material, not only sufficient cathode capacity (cathode density) but also sufficient battery capacity may be obtained.

In the third step, a separator and the cathode plate coated with the sacrificial material may be disposed between the anode current collector and the cathode current collector. Also, when the cathode plate and the cathode current collector are formed while attached to each other, the separator may be disposed between the anode current collector and the cathode plate. Moreover, in the third step, a liquid electrolyte may be provided between the anode current collector and the cathode plate.

As is apparent from the foregoing, according to the present invention, a lithium secondary battery and a method of manufacturing the same can be provided, in which battery lifespan performance can be improved by applying a sacrificial material onto a cathode plate using a deposition process, and output and capacity performance of the battery can be increased by improving electrical conductivity of a cathode.

The preferred embodiments of the present invention described above are disclosed for the purpose of illustration, and those skilled in the art having ordinary knowledge of the present invention will be able to make various modifications, changes, and additions within the spirit and scope of the present invention, and such modifications, changes, and additions should be considered to fall within the scope of the following claims.

### [National Research and Development Project Supporting the Invention]

[Project Identification Number] 1711195872
[Project Number] 00247245 [Ministry Name] Ministry of Science and ICT
[Project Management (Professional)Organization Name] National Research Foundation of Korea
[Research Business Name] STEAM Research (R&D)
[Research Project Name] Development of artificial intelligence platform for multi-angle-multi-scale data fusion-type lithium secondary battery design
[Project Performing Organization Name] BEI Lab Co., Ltd.
[Research Period] Apr. 1, 2023 to Dec. 31, 2027

### [National Research and Development Project Supporting the Invention]

[Project Identification Number] 2410000627
[Project Number] 00410241
[Ministry Name] Ministry of Trade, Industry and Energy
[Project Management (Professional)Organization Name] Korea Planning & Evaluation Institute of Industrial Technology
[Research Business Name] Automobile Industry Technology Development (R&D)
[Research Project Name] Development of next-generation lithium metal batteries for electric vehicles with high energy density and safety through inhibition of lithium dendrite growth
[Project Performing Organization Name] BEI Lab Co., Ltd.
[Research Period] Apr. 1, 2024 to Dec. 31, 2026

What is claimed is:

1. A lithium secondary battery configured such that a separator and a cathode plate are disposed between an anode current collector and a cathode current collector and an electrolyte is provided between the anode current collector and the cathode plate,
wherein the cathode plate is formed by pressing a cathode active material powder, and
the cathode plate is coated with a sacrificial material formed of a compound containing lithium.

2. The lithium secondary battery of claim 1, wherein the sacrificial material is formed of at least one selected from among lithium-containing oxides, chalcogenides, halides, nitrides, phosphates, carbonates, borates, silicates, sulfates, carbides, peroxides, amides, imides, and organolithium compounds.

3. The lithium secondary battery of claim 1, wherein the sacrificial material is applied onto the cathode plate after the cathode plate is formed from the cathode active material.

4. The lithium secondary battery of claim 3, wherein, after completion of formation of the cathode plate by pressing the cathode active material powder, the sacrificial material is applied onto an outer surface of the cathode plate and around pores in the cathode plate.

5. The lithium secondary battery of claim 3, wherein the cathode plate is formed by mixing the cathode active material powder with at least one of a binder material or a conductive material followed by pressing.

6. The lithium secondary battery of claim 3, wherein the sacrificial material is not applied onto a portion where cathode active material powder particles are pressed and in contact with each other.

7. The lithium secondary battery of claim 3, not comprising an anode active material or an anode plate.

8. A method of manufacturing a lithium secondary battery, comprising:
a first step of forming a cathode plate by pressing a cathode active material powder;
a second step of coating the cathode plate with a sacrificial material formed of a compound containing lithium; and
a third step of disposing a separator and the cathode plate coated with the sacrificial material between an anode current collector and a cathode current collector and providing an electrolyte between the anode current collector and the cathode plate.

9. The method of claim 8, wherein, after the cathode plate is formed from the cathode active material in the first step, the sacrificial material is applied onto the cathode plate in the second step.

10. The method of claim 9, wherein, in the second step, the sacrificial material is applied onto an outer surface of the cathode plate and around pores in the cathode plate.

11. The method of claim 9, wherein, in the first step, the cathode plate is formed by mixing the cathode active material powder with at least one of a binder material or a conductive material followed by pressing.

12. The method of claim 9, wherein, in the second step, the sacrificial material is not applied onto a portion where cathode active material powder particles are pressed and in contact with each other.

13. The method of claim 9, wherein the lithium secondary battery does not comprise an anode active material or an anode plate.
